(19) United States
(12) Patent Application Publication
(10) Pub. No.: US 2022/0383360 A1
(43) Pub. Date: Dec. 1, 2022

(54) ADVERTISEMENT CONTROL DEVICE, ADVERTISEMENT CONTROL METHOD, AND PROGRAM

(71) Applicant: Sharp NEC Display Solutions, Ltd, Tokyo (JP)

(72) Inventor: Akira UCHIYAMA, Tokyo (JP)

(21) Appl. No.: 17/776,090

(22) PCT Filed: Nov. 18, 2019
(86) PCT No.: PCT/JP2019/045089

§ 371 Date: May 11, 2022

(51) Int. Cl. G06Q 30/02

(52) U.S. Cl. CPC G06Q 30/0255; G06Q 30/0254; G06Q 30/0269; G06Q 30/0261

(57) ABSTRACT

An acquirer acquires last date information and at least one of frequency information and money amount information. The last date information indicates a last store visit date when a customer last visited a store or a last purchase date when the customer last purchased a product at the store. The frequency information indicates at least one of a frequency with which the customer has visited the store and a frequency with which the customer has made a purchase at the store. The money amount information is information about an amount of money of products purchased by the customer at the store. A product selector selects a product whose advertisement is required to be presented to the customer using at least one of the frequency information and the money amount information. On the basis of the last date information, an information amount determiner sets a condition.

### TECHNICAL FIELD

The present invention relates to an advertisement control device, an advertisement control method, and a program.

### BACKGROUND ART

One of the sales strategies implemented by a company for customers is to advertise and promote products. For example, Patent Literature 1 describes that the presence or absence of a service to be provided and a type thereof are determined according to the rank of a customer. In Patent Literature 1, the rank of the customer is determined by a total purchase amount, the number of days a store has been visited, and the like.

Also, Patent Literature 2 describes that a relationship between a company and a customer is built by referring to information of the customer and formulating an appropriate action plan. The action plan includes estimating, advertising, and promoting products that customers prefer.

### CITATION LIST

### Patent Literatures

### [Patent Literature 1]

Japanese Unexamined Patent Application, First Publication No. 2007-109168

### [Patent Literature 2]

Japanese Unexamined Patent Application, First Publication No. 2004-185598

### SUMMARY OF INVENTION

### Technical Problem

The present inventor has studied a method of selecting and providing an advertisement having a high sales promotion effect for each customer. An objective of the present invention is to select and provide an advertisement having a high sales promotion effect for each customer.

### Solution to Problem

According to the present invention, there is provided an advertisement control device including:

a product selector configured to select a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;

an information amount determiner configured to determine a condition relating to an amount of information included in the advertisement to be presented to the customer on the basis of last date information indicating a last store visit date when the customer last visited the store or a last purchase date when the customer last purchased a product at the store; and

a transmitter configured to transmit an advertisement, which relates to the product selected by the product selector and satisfies the condition determined by the information amount determiner, to a display and cause the display to display the advertisement.

According to the present invention, there is provided an advertisement control method including:

selecting, by a computer, a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;

determining, by the computer, a condition relating to an amount of information included in the advertisement to be presented to the customer on the basis of last date information indicating a last store visit date when the customer last visited the store or a last purchase date when the customer last purchased a product at the store; and

transmitting, by the computer, an advertisement, which relates to the selected product and satisfies the condition, to a display and causing the display to display the advertisement.

According to the present invention, there is provided a program for causing a computer to implement:

selecting a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;

determining a condition relating to an amount of information included in the advertisement to be presented to the customer on the basis of last date information indicating a last store visit date when the customer last visited the store or a last purchase date when the customer last purchased a product at the store; and

transmitting an advertisement, which relates to the selected product and satisfies the condition, to a display and causing the display to display the advertisement.

### Advantageous Effects of Invention

According to the present invention, it is possible to select and provide an advertisement having a high sales promotion effect for each customer.

### BRIEF DESCRIPTION OF DRAWINGS

The above-described objective and other objectives, features, and advantages will be further clarified using a preferred embodiment to be described below and the accompanying drawings below.

FIG. 1 is a diagram for describing a usage environment of an advertisement control device according to an embodiment.

FIG. 2 is a diagram showing an example of a functional configuration of the advertisement control device.

FIG. 3 is a diagram for describing an example of a process performed by a product selector.

FIG. 4 is a diagram for describing an example of a process performed by the product selector.

FIG. 5 is a diagram for describing an example of a process performed by an information amount determiner.

FIG. 6 is a diagram showing an example of information stored in a customer information storage.

FIG. 7 is a diagram showing an example of information stored in a product information storage.

FIG. 8 is a diagram showing an example of information stored in an advertisement information storage.

FIG. 9 is a diagram for describing an example of an advertisement stored in the advertisement information storage.

FIG. 10 is a block diagram illustrating a hardware configuration of main parts of the advertisement control device.

FIG. 11 is a flowchart showing an example of a process performed by the advertisement control device.

FIG. 12 is a flowchart showing a first example of step S40 in FIG. 11.

FIG. 13 is a flowchart showing a second example of step S40 in FIG. 11.

### DESCRIPTION OF EMBODIMENTS

Hereinafter, an embodiment of the present invention will be described using drawings. In all the drawings, similar constituent elements are denoted by similar reference signs and description thereof will be omitted appropriately.

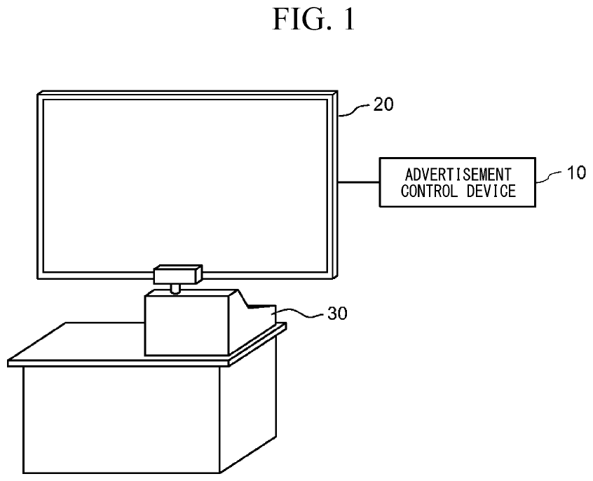

FIG. 1 is a diagram for describing a usage environment of an advertisement control device 10 according to the embodiment. The advertisement control device 10 selects an advertisement to be shown to a customer and causes a display device 20 to display the selected advertisement. The display device 20 is installed in a store and can be visually recognized by the customer. An installation position of the display device 20 is, for example, near an accounting device 30. In this case, the customer can see the advertisement displayed on the display device 20 between the registration of a product desired to be purchased and payment or after payment is completed. However, the display device 20 may be installed at the entrance/exit of the store, inside a show window, and on the outer wall of the store.

The advertisement control device 10 selects an advertisement to be displayed on the display device 20 using a previous purchase history, a store visit history, and the like of the customer. At this time, the advertisement control device 10 also uses information about a product that is a processing target in the accounting device 30 as necessary, in other words, information about a product purchased by the customer at the store at that time, when the advertisement is selected.

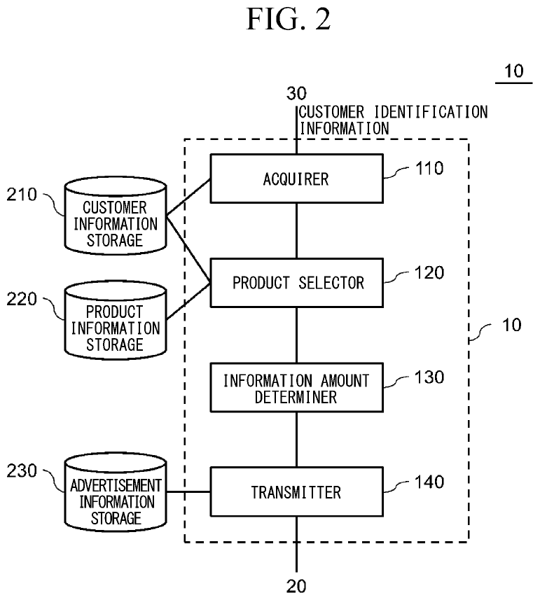

FIG. 2 is a diagram showing an example of a functional configuration of the advertisement control device 10. The advertisement control device 10 has an acquirer 110, a product selector 120, an information amount determiner 130, and a transmitter 140. The acquirer 110 acquires last date information and at least one of frequency information and money amount information. The last date information indicates a last visit date when the customer last visited the store or a last purchase date when the customer last purchased the product at the store. The last date information may include both the last visit date and the last purchase date. The frequency information indicates at least one of a frequency with which the customer has visited the store and a frequency with which the customer has made a purchase at the store. The money amount information is information about an amount of money of products purchased by the customer at the store. The product selector 120 selects a product whose advertisement is required to be presented to the customer using at least one of the frequency information and the money amount information. The information amount determiner 130 determines a condition relating to an amount of information included in the advertisement to be presented to the customer on the basis of the last date information. The transmitter 140 transmits an advertisement, which relates to the product selected by the product selector 120 and satisfies the condition determined by the information amount determiner 130, to the display device 20 and causes the display device 20 to display the advertisement. Details of processes performed by the product selector 120, the information amount determiner 130, and the transmitter 140 will be described below.

The advertisement control device 10 can be connected to the customer information storage 210, the product information storage 220, and the advertisement information storage 230. The customer information storage 210 stores information about customers. The product information storage 220 stores information about products. The advertisement information storage 230 stores a plurality of types of advertisements having different amounts of information for each product. The product selector 120 of the advertisement control device 10 selects a product to be advertised using the product information storage 220. The transmitter 140 reads an advertisement from the advertisement information storage 230 and causes the display device 20 to display the advertisement.

Also, the customer information storage 210, the product information storage 220, and the advertisement information storage 230 may be parts of the advertisement control device 10 or may be outside the advertisement control device 10. In the latter case, these storages are, for example, parts of a store server. The advertisement control device 10 may be connected to these storages via the Internet or may be connected to these storages via a local network.

Also, the customer information storage 210 is preferably managed by a point of sale (POS) system. When the customer information storage 210 is a part of the advertisement control device 10, the customer information storage 210 is updated in conjunction with the information stored in the POS system.

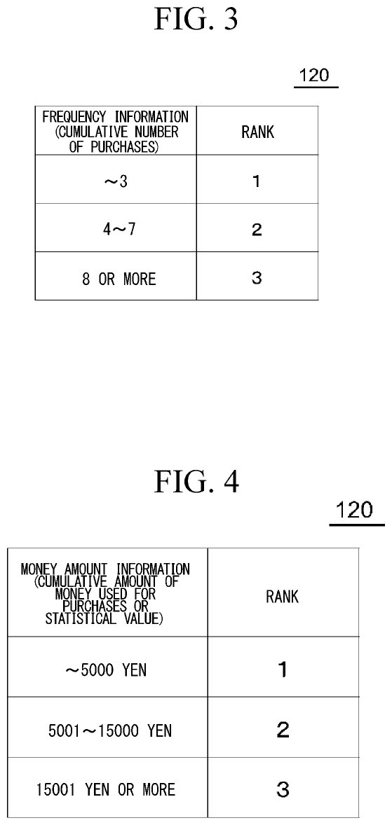

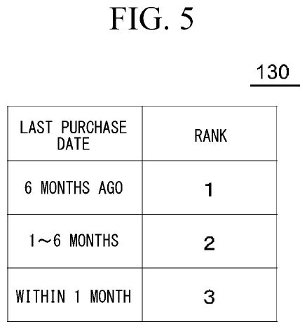

FIGS. 3 and 4 are diagrams for describing an example of a process performed by the product selector 120. In the present example, the product selector 120 assigns a frequency rank to the customer using the frequency information and assigns a purchase price rank to the customer using the money amount information. For example, the product selector 120 raises the rank of the customer as the purchase frequency indicated in the frequency information, for example, the cumulative number of purchases for a prescribed period (for example, the last 6 months), increases. Also, the product selector 120 raises the rank of the customer as an amount of money used for a purchase, for example, a cumulative amount of money used for purchases for a prescribed period (for example, the last 6 months), or a unit price of a product increases. In these examples, the product selector 120 may assign the rank for each product classification.

The product selector 120 selects a product using at least one of the rank of the frequency and the rank of the amount of money used for the purchase. Specific examples of product selection will be described below using a flowchart.

FIG. 5 is a diagram for describing an example of a process performed by the information amount determiner 130. In this example, the information amount determiner 130 assigns a rank associated with the last date to the customer using the last date information (for example, the last purchase date). The information amount determiner 130 raises the rank of the customer as the date indicated in the last date information becomes closer to the current date. The information amount determiner 130 sets a condition relating to an amount of information of an advertisement using the rank associated with the last date. As an example, the information amount determiner 130 increases the amount of information of the advertisement as the rank becomes higher (i.e., as the date indicated in the last date information is updated).

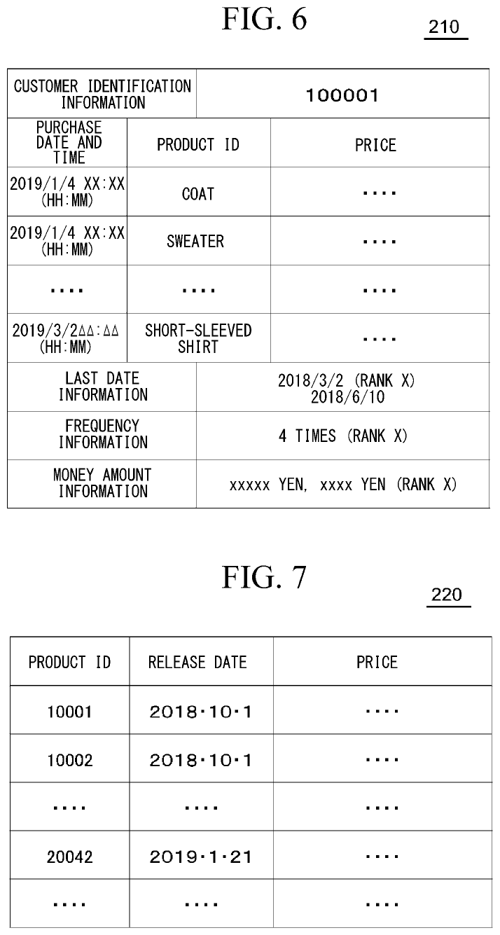

FIG. 6 is a diagram showing an example of information stored in the customer information storage 210. In the example shown in FIG. 6, information for distinguishing a customer from other customers (hereinafter referred to as customer identification information), for example, a member ID, is assigned to the customer. The customer information storage 210 stores a file for each piece of customer identification information. This file stores a purchase history of the customer. The purchase history includes a date and time when a product was purchased, product identification information (for example, a product ID) for identifying a product that was purchased at that time, and a price of the product.

Also, the customer information storage 210 stores the last date information, the frequency information, and the money amount information for each piece of customer identification information. This information is updated every time the customer purchases a product. Also, the money amount information includes a total amount of money used to purchase products and a statistical value of a unit price (for example, an average value, a median value, a maximum price, or the like). Here, the customer information storage 210 may store ranks (see FIGS. 3 to 5) corresponding to the last date information, the frequency information, and the money amount information. Here, the customer information storage 210 stores the latest last date information and the previous last date information as the last date information. A rank corresponding to the last date information is set on the basis of the previous last date information.

FIG. 7 is a diagram showing an example of information stored in the product information storage 220. In the example shown in FIG. 7, the product information storage 220 stores a release date (or a scheduled release date in the case of the date before the release) and a price of a product indicated in the product identification information for each piece of product identification information. The product identification information also includes information indicating the classification (product classification) to which the product belongs. For example, when the product is clothing, the product classification is tops, bottoms, coats, or the like.

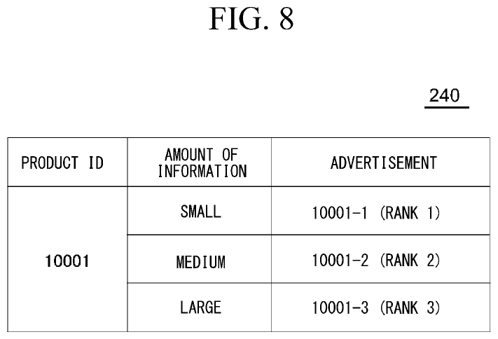

FIG. 8 is a diagram showing an example of information stored in the advertisement information storage 230. The advertisement information storage 230 stores an advertisement of a product indicated in the product identification information for each piece of product identification information. Also, the advertisement information storage 230 stores a plurality of advertisements having different amounts of information for one piece of product identification information. The advertisement information storage 230 stores the plurality of advertisements in association with the rank of the customer based on the last date information. Also, the advertisement stored in the advertisement information storage 230 may be moving image data or still image data. Also, this advertisement may have audio data or may not have audio data.

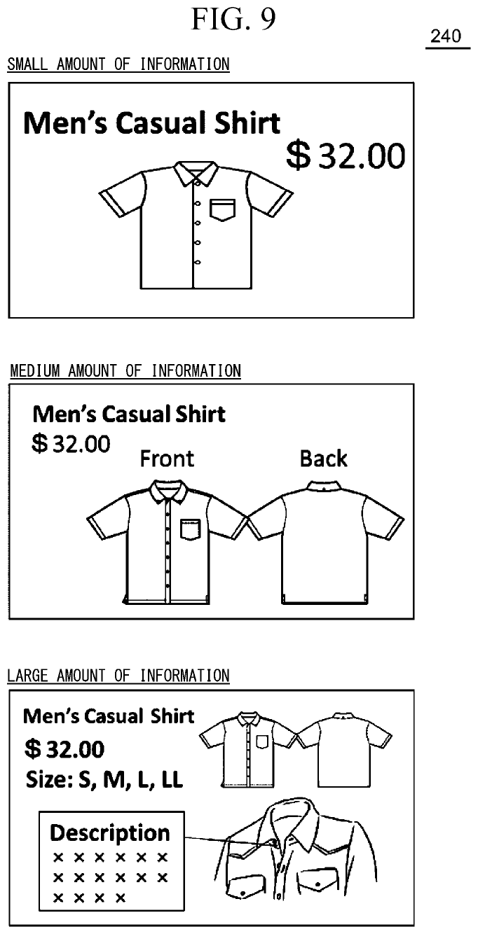

FIG. 9 is a diagram for describing an example of the advertisement stored in the advertisement information storage 230. As described above, the advertisement information storage 230 stores a plurality of advertisements for one product. The plurality of advertisements have different amounts of information. Here, a large amount of information means that there is a large amount of information about a product. In the example shown in FIG. 9, the advertisement information storage 230 stores three types of advertisements for one product. An advertisement with the smallest amount of information includes a product name, an image when a product is viewed from a single direction, and a price of the product and an advertisement with the second smallest amount of information is obtained by adding images when the product is viewed from other directions to the advertisement with the smallest amount of information. An advertisement with the largest amount of information is obtained by adding detailed information of the product to the advertisement with the second smallest amount of information.

As described above, each advertisement is associated with the rank corresponding to the last date information of the customer. As an example, the lower the rank based on the date indicated in the last date information is, the smaller the amount of information contained in the advertisement is. The reason for this is that if this rank is low, it is assumed that the customer has little interest in the company and therefore the amount of information is required to be narrowed down.

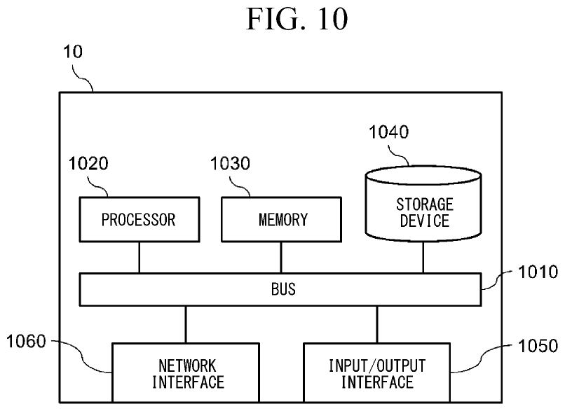

FIG. 10 is a block diagram illustrating a hardware configuration of main parts of the advertisement control device 10. The main parts include a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, a method of connecting the processor 1020 and the like to each other is not limited to a bus connection.

The processor 1020 is a processor implemented by a central processing unit (CPU), a graphics processing unit (GPU), or the like.

The memory 1030 is a main storage device implemented by a random-access memory (RAM) or the like.

The storage device 1040 is an auxiliary storage device implemented by a hard disk drive (HDD), a solid-state drive (SSD), a memory card, a read-only memory (ROM), or the like. The storage device 1040 stores a program module that implements functions (for example, an acquirer 110, a product selector 120, an information amount determiner 130, and a transmitter 140) of the advertisement control device 10. When the processor 1020 reads each of these program modules into the memory 1030 and executes each program module, each function corresponding to the program module is implemented. Also, the storage device 1040 functions as various types of storages (for example, a customer information storage 210, a product information storage 220, and an advertisement information storage 230), if necessary.

The input/output interface 1050 is an interface for connecting the main parts of the advertisement control device 10 and various types of input/output devices.

The network interface 1060 is an interface for connecting the advertisement control device 10 to other devices (for example, the display device 20 and the accounting device 30) on the network. However, the network interface 1060 may not be used.

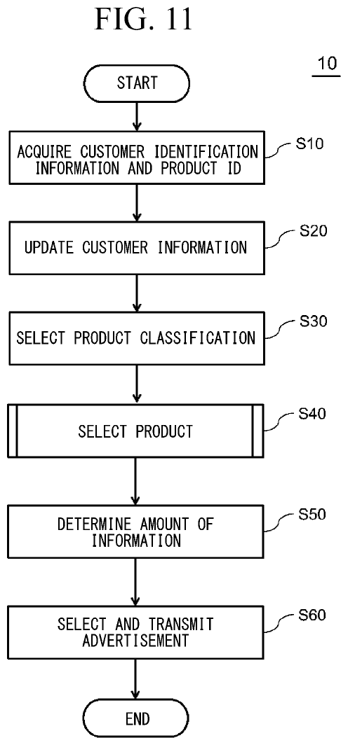

FIG. 11 is a flowchart showing an example of a process performed by the advertisement control device 10. In the example shown in FIG. 11, the advertisement control device 10 operates when a customer purchases a product.

First, the customer brings the product to be purchased to the accounting device 30. A person (a clerk or the customer) who operates the accounting device 30 causes the accounting device 30 to read product identification information (for example, a product ID) of the product from a tag attached to the product. The accounting device 30 also reads customer identification information of the customer from a terminal or a card possessed by the customer (step S10). The accounting device 30 performs a payment process using the read information.

Also, the accounting device 30 transmits the product identification information and the customer identification information read in step S10 to the advertisement control device 10. At this time, the accounting device 30 transmits detailed information (for example, a price) of a purchased product and a purchase date and time to the advertisement control device 10. When the acquirer 110 of the advertisement control device 10 acquires the product identification information and the customer identification information from the accounting device 30, the acquirer 110 updates the customer information storage 210 using the above information. Specifically, the acquirer 110 causes the customer information storage 210 to store a purchase date and time, product identification information, and a price that have currently been acquired in association with the currently acquired customer identification information and updates the last date information, the frequency information, and the money amount information (step S20). At this time, the customer information storage 210 also stores the last date information immediately before the update. Thereby, when the advertisement control device 10 selects an advertisement, information of a currently purchased product is also reflected in a selection criterion.

Also, when the customer is a new customer, i.e., when the information corresponding to the currently acquired customer identification information is not stored in the customer information storage 210, the acquirer 110 newly creates a file corresponding to the customer identification information.

The product selector 120 reads at least one of the last date information before the update, the frequency information, and the money amount information from the customer information storage 210. At this time, the product selector 120 reads product identification information of a product previously purchased by the customer (i.e., a product purchase history) from the customer information storage 210. The product selector 120 selects a product classification for which the advertisement is required to be provided to the customer, for example, using the purchase history (step S30).

As an example, the product selector 120 analyzes the customer's preference using the product included in the purchase history and selects the product classification according to the preference. For example, the product selector 120 identifies a product classification with the highest purchase frequency as the customer's preferred product classification. Also, the product selector 120 calculates an average value of an amount of money used for a purchase for each product classification and identifies a product classification having the calculated average value larger than a median value of average values of other purchasers (or the average values thereof) as the customer's preferred product classification. Here, the product selector 120 may select a plurality of product classifications.

Subsequently, the product selector 120 selects a product for which an advertisement is required to be provided to a customer from products included in the selected product classification and identifies product identification information of the selected product (step S40). The details of this process will be described below.

Subsequently, the information amount determiner 130 identifies a rank of the customer based on the last date information before the update using the last date information read by the product selector 120 in step S10 (step S50). The rank of the customer corresponds to a condition relating to an amount of information. Subsequently, the transmitter 140 reads an advertisement corresponding to the rank identified in step S50 among advertisements corresponding to the product identification information identified in step S40 from the advertisement information storage 230. The transmitter 140 transmits the read advertisement to the display device 20 and causes the display device 20 to display the advertisement. Thereby, it is possible to increase a purchase frequency of the customer.

Thereby, the customer who has purchased the product through the accounting device 30 can recognize the advertisement via the display device 20 during or immediately after the purchase process.

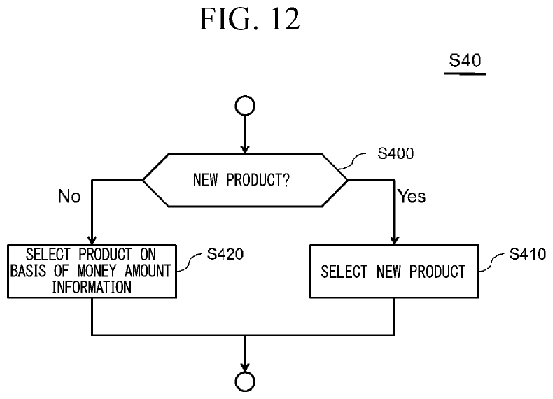

FIG. 12 is a flowchart showing a first example of step S40 in FIG. 11. First, the product selector 120 confirms whether or not there is a product whose release date is later than a date indicated in the last date information read in step S20 of FIG. 11 among products stored in the product information storage 220 (step S400). When there is a product whose release date is later than the date indicated in the last date information (step S400), the product selector 120 selects the product (step S410).

When there are a plurality of products here, a product belonging to the product classification identified in step S30 of FIG. 11 among these products is preferentially selected or a product having a new (or old) release date is preferentially selected.

Also, the product selector 120 may select a product using money amount information. In this case, the product selector 120 selects the product using a statistical value of a price of the product included in the money amount information. For example, the product selector 120 may select a product having a price that is at least a reference value higher than an average unit price or a median value, may select a product having a price within the reference value above and below the average unit price, or may select a product of a maximum amount of money or less. Here, the product information storage 220 may store product identification information in association with a rank based on the amount of money (corresponding to the rank in FIG. 4). In this case, the product selector 120 may select the product associated with a rank corresponding to the rank of the money amount information.

Also, the product selector 120 may identify a store visit cycle of the customer using the customer's purchase history (an example of store visit cycle information) stored in the customer information storage 210. In this case, the product selector 120 may identify an expected store visit date when the customer is expected to visit the store for the next time using the store visit cycle information and the last date information and select a product to be released after the date indicated in the last date information and before the expected store visit date.

On the other hand, when there is no product whose release date is later than a date indicated in the last date information (step S400: No), the product selector 120 selects a product belonging to the product classification identified in step S30 of FIG. 11 (step S420).

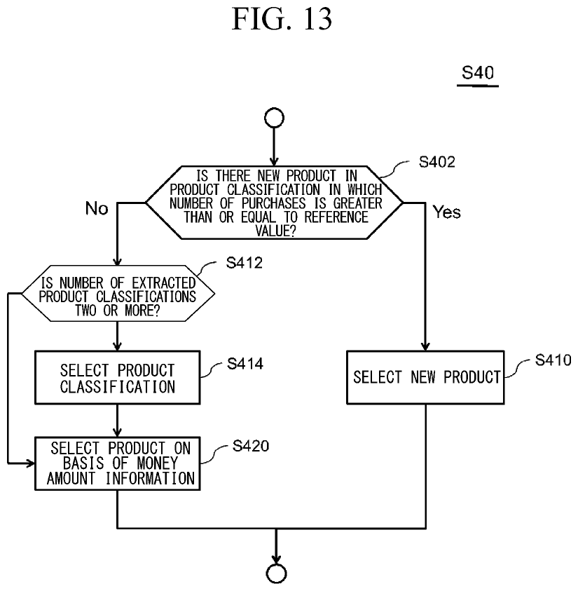

FIG. 13 is a flowchart showing a second example of step S40 in FIG. 11. First, the product selector 120 determines whether or not there is a new product (i.e., a product released after the date indicated in the last date information) in the product classification in which the number of purchases is greater than or equal to a reference value (step S402). When there is a corresponding product (step S402: Yes), the product selector 120 selects the product (step S410). A detailed example of step S410 is as described with reference to FIG. 12.

On the other hand, when there is no new product in the product classification in which the number of purchases is greater than or equal to the reference value (step S402: No), the product selector 120 determines whether or not the number of product classifications identified in step S30 of FIG. 11 is one (step S412). When there are a plurality of products (step S412: Yes), the product selector 120 selects a product classification on the basis of a preset rule (step S416) and selects a product using the selected product classification (step S420). A detailed example of step S420 is as described with reference to FIG. 12.

The rule used in step S416 is set, for example, by a store manager. For example, the manager may give priority to product classifications in the order in which he or she wants to promote sales. The product selector 120 selects the product classification using this priority.

As described above, the advertisement control device 10 according to the present embodiment selects a product whose advertisement is required to be presented to the customer using at least one of the frequency information and the money amount information and determines a condition relating to an amount of information included in the advertisement to be presented to the customer on the basis of the last date information. Therefore, it is possible to select and provide an advertisement having a high sales promotion effect for each customer.

Although the embodiments of the present invention have been described above with reference to the drawings, these are examples of the present invention and various configurations other than the above-described configuration can be adopted.

Although a plurality of processing steps (processes) have been described in order in the plurality of flowcharts used in the above description, the order in which the processing steps are executed in each embodiment is not limited to the order described in the embodiments. In each embodiment, the order of the processing steps shown in the drawing can be changed in a range without causing a problem in content. Also, the above-described embodiments can be combined in a range in which content does not conflict.

Although some or all of the above-described embodiments can be described as in the following appendixes, the present invention is not limited to the following appendixes.

1. An advertisement control device including:

a product selector configured to select a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;

an information amount determiner configured to determine a condition relating to an amount of information included in the advertisement to be presented to the customer on the basis of last date information indicating a last store visit date when the customer last visited the store or a last purchase date when the customer last purchased a product at the store; and

a transmitter configured to transmit an advertisement, which relates to the product selected by the product selector and satisfies the condition determined by the information amount determiner, to a display and cause the display to display the advertisement.

2. The advertisement control device according to appendix 1, wherein the information amount determiner determines the condition so that the amount of information is increased when a date indicated in the last date information is updated.

3. The advertisement control device according to appendix 1 or 2, wherein the product selector selects a product to be released after a date indicated in the last date information.

4. The advertisement control device according to appendix 3, wherein the product selector identifies an expected store visit date when the customer is expected to visit the store for the next time using store visit cycle information for identifying a store visit cycle at which the customer has visited the store and the last date information and selects a product to be released after the date indicated in the last date information and before the expected store visit date.

5. The advertisement control device according to appendix 1,

wherein the money amount information indicates a statistical value of a unit price of a product purchased by the customer at the store, and

wherein the product selector selects a product whose price is higher than the statistical value.

6. The advertisement control device according to any one of appendixes 1 to 5,

wherein the display is provided at the store,

wherein the transmitter causes the display to display an advertisement when the customer has purchased one product at the store,

wherein the purchase of the one product is reflected in the money amount information, and

wherein the product selector selects a product serving as an advertisement target using the money amount information.

7. An advertisement control method including:

selecting, by a computer, a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;

determining, by the computer, a condition relating to an amount of information included in the advertisement to be presented to the customer on the basis of last date information indicating a last store visit date when the customer last visited the store or a last purchase date when the customer last purchased a product at the store; and

transmitting, by the computer, an advertisement, which relates to the selected product and satisfies the condition, to a display and causing the display to display the advertisement.

8. The advertisement control method according to appendix 7, wherein the computer determines the condition so that the amount of information is increased when a date indicated in the last date information is updated.

9. The advertisement control method according to appendix 7 or 8, wherein the computer selects a product to be released after a date indicated in the last date information.

10. The advertisement control method according to appendix 9, wherein the computer identifies an expected store visit date when the customer is expected to visit the store for the next time using store visit cycle information for identifying a store visit cycle at which the customer has visited the store and the last date information and selects a product to be released after the date indicated in the last date information and before the expected store visit date.

11. The advertisement control method according to appendix 7,

wherein the money amount information indicates a statistical value of a unit price of a product purchased by the customer at the store, and

wherein the computer selects a product whose price is higher than the statistical value.

12. The advertisement control method according to any one of appendixes 7 to 11,

wherein the display is provided at the store,

wherein the computer causes the display to display an advertisement when the customer has purchased one product at the store,

wherein the purchase of the one product is reflected in the money amount information, and

wherein the computer selects a product serving as an advertisement target using the money amount information.

13. A program for causing a computer to implement:

selecting a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;

determining a condition relating to an amount of information included in the advertisement to be presented to the customer on the basis of last date information indicating a last store visit date when the customer last visited the store or a last purchase date when the customer last purchased a product at the store; and

transmitting an advertisement, which relates to the selected product and satisfies the condition, to a display and causing the display to display the advertisement.

14. The program according to appendix 13, wherein the computer is allowed to determine the condition so that the amount of information is increased when a date indicated in the last date information is updated.

15. The program according to appendix 13 or 14, wherein the computer is allowed to select a product to be released after a date indicated in the last date information.

16. The program according to appendix 15, wherein the computer is allowed to identify an expected store visit date when the customer is expected to visit the store for the next time using store visit cycle information for identifying a store visit cycle at which the customer has visited the store and the last date information and select a product to be released after the date indicated in the last date information and before the expected store visit date.

17. The program according to appendix 13,

wherein the money amount information indicates a statistical value of a unit price of a product purchased by the customer at the store, and

wherein the computer is allowed to select a product whose price is higher than the statistical value.

18. The program according to any one of appendixes 13 to 17,

wherein the display is provided at the store,

wherein the computer is allowed to cause the display to display an advertisement when the customer has purchased one product at the store,

wherein the purchase of the one product is reflected in the money amount information, and

wherein the computer is allowed to select a product serving as an advertisement target using the money amount information.

### REFERENCE SIGNS LIST

10 Advertisement control device
20 Display device
30 Accounting device
110 Acquirer
120 Product selector
130 Information amount determiner
140 Transmitter
210 Customer information storage
220 Product information storage
230 Advertisement information storage

1. An advertisement control device comprising:
a product selector configured to select a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;
an information amount determiner configured to determine a condition relating to an amount of information included in the advertisement to be presented to the customer on the basis of last date information indicating a last store visit date when the customer last visited the store or a last purchase date when the customer last purchased a product at the store; and
a transmitter configured to transmit an advertisement, which relates to the product selected by the product selector and satisfies the condition determined by the information amount determiner, to a display and cause the display to display the advertisement.

2. The advertisement control device according to claim 1,
wherein the information amount determiner determines the condition so that the amount of information is increased when a date indicated in the last date information is updated.

3. The advertisement control device according to claim 1,
wherein the product selector selects a product to be released after a date indicated in the last date information.

4. The advertisement control device according to claim 3,
wherein the product selector identifies an expected store visit date when the customer is expected to visit the store for the next time using store visit cycle information for identifying a store visit cycle at which the customer has visited the store and the last date information and selects a product to be released after the date indicated in the last date information and before the expected store visit date.

5. The advertisement control device according to claim 1,
wherein the money amount information indicates a statistical value of a unit price of a product purchased by the customer at the store, and
wherein the product selector selects a product whose price is higher than the statistical value.

6. The advertisement control device according to claim 1,
wherein the display is provided at the store,
wherein the transmitter causes the display to display an advertisement when the customer has purchased one product at the store,
wherein the purchase of the one product is reflected in the money amount information, and
wherein the product selector selects a product serving as an advertisement target using the money amount information.

7. An advertisement control method comprising:
selecting, by a computer, a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;
determining, by the computer, a condition relating to an amount of information included in the advertisement to be presented to the customer on the basis of last date information indicating a last store visit date when the customer last visited the store or a last purchase date when the customer last purchased a product at the store; and
transmitting, by the computer, an advertisement, which relates to the selected product and satisfies the condition, to a display and causing the display to display the advertisement.

8. A non-transitory computer readable recording medium storing a program for causing a computer to implement:
selecting a product whose advertisement is required to be presented to a customer using at least one of frequency information indicating at least one of a frequency with which the customer has visited a store and a frequency with which the customer has made a purchase at the store and money amount information about an amount of money of products purchased by the customer at the store;
determining a condition relating to an amount of information included in the advertisement to be presented to the customer on the basis of last date information indicating a last store visit date when the customer last visited the store or a last purchase date when the customer last purchased a product at the store; and
transmitting an advertisement, which relates to the selected product and satisfies the condition, to a display and causing the display to display the advertisement.
